(19) United States
(12) Patent Application Publication
(10) Pub. No.: US 2014/0208351 A1
(43) Pub. Date: Jul. 24, 2014

(54) VIDEO PROCESSING APPARATUS, METHOD AND SERVER

(71) Applicants: Sony Europe Limited, Weybridge (GB); SONY CORPORATION, Minato-ku (JP)

(72) Inventor: Nigel MOORE, Newbury (GB)

(73) Assignees: Sony Europe Limited, Weybridge (GB); SONY CORPORATION, Minato-ku (JP)

(21) Appl. No.: 14/055,399

(22) Filed: Oct. 16, 2013

(30) Foreign Application Priority Data
Jan. 23, 2013 (GB) 1301194.5

(51) Int. Cl. H04N 21/485

(52) U.S. Cl. CPC H04N 21/4856
USPC 725/35

(57) ABSTRACT

A video processing apparatus comprises a controller and a communications unit that receives video data representing a video image for display from a source and receives first data representing text to be reproduced within the video image, the text being in accordance with a first language. The controller is configured to communicate the first data to a remote terminal using the communications unit. The remote terminal converts the text from the first language to a second language, and to form second data to receive second data representing the text in the second language. The video processing apparatus further includes a video processor that is configured to process the video data and the second data to generate display signals for reproducing the video images with the text according to the second language inserted onto the video images, the text associated with the video images.

### CROSS REFERENCE TO RELATED APPLICATION

The present application claims priority to United Kingdom patent application No GB1301194.5, filed in the UKIPO on 23 Jan. 2013, the entire contents of which being incorporated herein by reference.

### BACKGROUND

1. Field of the Disclosure

The present disclosure relates to video processing apparatus for example set top boxes, client devices or video processors which are adapted to generate video signals for the display, for example on a television.

Embodiments of the present technique can provide an arrangement for displaying text within video images such as sub-titles or the like in which the language of the text is adapted to meet a user's requirements.

2. Description of Related Art

It is known to provide sub-titles within video images to allow a user who is not familiar with the language in which the audio sound track of the video signals is broadcast to understand and follow the content of the audio sound track. For example, video signals which are transmitted with an audio sound track providing an audible commentary or speech in Japanese can be provided with data representing text for example in the English language so that a person who does not understand Japanese can follow and understand the content of the speech and follow action in the video images. This may be required for several reasons, for example, the user may not understand the language in which the original audio soundtrack is broadcast or the user may be deaf or hard of hearing and therefore can only read text representing the speech in the sound track accompanying the video signals. In another example, a hearing person may prefer to receive the original sound and follow the speech using so-called sub-titles.

It is known to provide data accompanying video signals in which the data provides the text for insertion into the video images represented by the video signals thereby providing sub-titles to the viewer. Furthermore, it is known to provide data in which the text is represented in more than one language. However, there remains a technical problem because it is not possible to provide text in all the languages in which the video and audio signals may be received by a user and a user may have a particular requirement for a language which is not available within a file.

As will be appreciated it is therefore desirable to improve a quality of video images and audio sound tracks where text is to be reproduced within or overlaid on the video images.

### SUMMARY OF THE DISCLOSURE

According to an aspect of the present disclosure there is provided a video processing apparatus, the video processing apparatus comprising a communications unit, a video processor and a controller. The controller and the communications unit are configured in combination to receive video data representing video images for display from a source, to receive first data representing the text to be reproduced within the video image, the text being in accordance with a first language. The controller is configured to communicate the first data to a remote terminal using the communications unit, the remote terminal being configured to convert the text from the first language to a second language and to form second data to receive second data representing the text in the second language. A video generation processor is configured to process the video data and the second data to generate display signals for reproducing the video images with the text according to the second language inserted into the video images, the text being associated with the video images.

Embodiments of the present technique can provide an arrangement in which a video processing apparatus is configured to generate text in a second language when the video signals are received with first data providing text in a first language. The video generation apparatus communicates the first data representing the text in the first language to a remote terminal and receives from the remote terminal second data representing the text in the second language for display to the user in the second language. Accordingly, a translation service can be provided for example on a remote server in which the first language is converted to the second language for display to the user.

Furthermore, in some examples the text in accordance with the second language is adapted so that the text occupies the same area in the video images as the text in the first language. This is because some languages require a different number of words and different arrangement of words in order to convey the same meaning as other languages. For example, it is generally true that the number of words in German and French exceeds that of English to convey the same meaning. Accordingly, by adapting the text by puncturing words, abbreviating words, wrapping text around or reducing the font size so that the text in the second language occupies the same area in the video images as the first language, then the displayed sub-title text will not obscure a greater area within the video images which are being displayed. In some examples the video images may include a reserved area for images which must not be overlaid with text forming the subtitles. Accordingly, the video processing apparatus may adapt the text according to the second language so that when displayed it does not interfere with the reserve area.

Various further aspects and features of the present disclosure are defined in the appended claims which include a remote terminal, a method of processing video images and a method of translating text for inserting into video images.

### BRIEF DESCRIPTION OF DRAWINGS

Embodiments of the present disclosure will now be described by way of example only with reference to the accompanying drawings in which like parts are provided with the same numerical references and wherein:

FIG. 1 is a schematic block diagram representing an example arrangement in which a video processing apparatus which may form a client device or a set-top box receives video and audio data in combination with data representing text of a first language and displays the video images with text in a second language;

FIG. 2 is an example of a file format in which data representing text for displaying within images is received;

FIG. 3a is a schematic representation of an example data file structure for conveying the audio/video data with text data; FIG. 3b is another representation of a data file structure in which audio/video data/text data is transported as an DASH MPD (XML) file; and FIG. 3C is an example of a data file structure in which audio/video data/text data is transported as a fragment of an MPEG 4 file;

FIG. 4 is a schematic illustration of a video image in which text in a first language (English) is replaced with text in a second language (German);

FIG. 5a is a schematic representation of a video image in which a reserved area of the video images is shown as an example illustration; and FIG. 5b is a representation of the image of FIG. 5a in which the text in the first language (English) has been translated into the text of the second language (Spanish) and the reserved area has not been overwritten by adapting the text in a second language (Spanish) to ensure that it does not interfere with a reserved area;

FIG. 6 is a flow diagram representing one example operation of a video processing apparatus; and

FIG. 7 is a flow diagram representing one example operation of a terminal providing a service for translation text for inserting into video images.

### DESCRIPTION OF EXAMPLE EMBODIMENTS

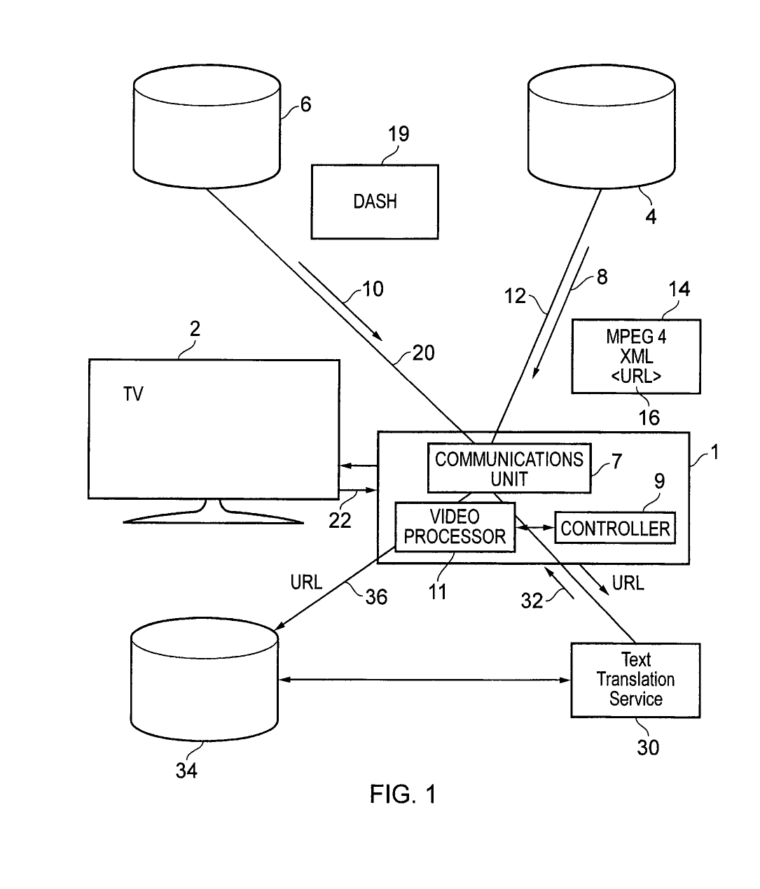

Example embodiments of the present disclosure provide an arrangement for generating text in a language which is preferred by a user for display within video images, so that a language which is not otherwise available from received video and audio data representing the video images can be retrieved and displayed to the user in accordance with the user's preference. In one example, the text is translated from a first language to a second language using a translation service which may be hosted on a remote server. An example embodiment of the present disclosure is shown in FIG. 1.

In FIG. 1 a video processing apparatus which may form a client device 1 with respect to other networked devices may be for example a set-top box or a personal computer which is arranged to generate at least video signals, but may of course include audio signals which are communicated to a display device 2 or equivalent display device such as a television for generating video images for viewing with or without an audible sound track. Other examples are of course possible in which the video processing apparatus 1 forms part of a portable computing apparatus such as a tablet computer for both generating video and/or audio signals and for converting the video signals into viewable images and audio signals into sound.

For the example shown in FIG. 1, the video signals and audio signals are received from one or more remote servers 4, 6 by a communications unit 7 which may for example, be retrieved or streamed via an internet connection using an internet protocol, in which case the set-top box 1 forms a client device and the servers 4, 6 communicate the video signals by streaming the audio and video signals as represented by arrows 8, 10. In one example, from a first of the servers 4 a data file representing video and/or audio data is streamed from the first server 4 to the video processing apparatus 1 via an internet connection 12 in which the video and/or audio data are provided as an MPEG 4 file 14. The data representing the video and/or audio data in one example may be encoded using MPEG 4. In one example, the file 14 forms part of and is conveyed by an extended mark-up language (XML) file which includes a URL 16 providing a location of text and information identifying a timing for display of the text within the video signals, when the video signals are reproduced with the text forming the subtitles. In one example the file has a format using TTML or WebVTT.

In a second example, a second of the servers 6 is arranged to stream data (indicated by an arrow 10) representing video signals and/or audio data in the form of a file 19 which is communicated via an internet connection 20. The file 19 may be also a TTML or WebVTT file which includes text and information providing a timing for display of the text within the video signals.

Conventionally, a video processor 11 under the control of a controller 9 in the video processing apparatus 1 processes the streamed audio/video signals for generating the video images on the television 2 with text displayed within the video images so that a user who requires subtitles to be displayed within the video images can read the text along with viewing the video images. The video processor 11 processes the video data received for example in one of the data files 14, 19 and the data representing the text and generates video signals with the text overlaid within the video images. Conventionally, the text which is presented to the user within the video images is in accordance with the language provided within the received data file 14, 19, such for example is the files are XML files 14.

According to one example the video processing apparatus 1 is arranged to provide a menu to a user for selecting a preferred language for example, via a graphical user interface presented on the television 2. Thus, the video processing apparatus 1 receives an indication from the user of a preferred language which is represented by an arrow 22. However if the video processing apparatus 1 determines that the language is not present within the received data file accompanying the audio/video data from either TTML or WebVTT file 14, 19 then the video processing apparatus arranges for the text to be translated into the preferred language of the user.

According to example embodiments of the present technique the video processing apparatus 1 communicates with a translation service which may be hosted on a remote server or terminal 30 as shown for the example shown in FIG. 1. The translation service on the remote terminal 30 receives the data representing the text in a first of the languages which is available to the video processing apparatus 1 and arranges for the text to be translated into a second language and communicates the data representing the text in the second language back to the client 1 as represented by an arrow 32.

There are various ways in which the text according to a first language which is available to the video processing apparatus 1 can be communicated to the translation service hosted by the remote terminal 30 and in which the remote terminal 30 can communicate data representing the text in the second language back to the video processing apparatus 1. In one example the video processing apparatus 1 receives the text providing the first language within the video and audio data in the form of an XML file such as a DASH file. The XML file may include a URL indicating a location of the text within the World Wide Web where the text is available. In this example, the video processing apparatus 1 then communicates the URL to the remote terminal 30 requesting a translation into the second language. The remote terminal 30 can access the data representing the text in the first language using the URL by accessing a server 34 thus retrieving the text according to the first language and performing a translation of the text and then communicating the text according to the second language back to the remote video processing apparatus 1. Alternatively, the video processing apparatus 1 can access the text using the URL as represented by an arrow 36 and communicate data representing the text in the first language to the remote terminal 30 which can then perform the translation and send data representing the text in the second language back to the video processing apparatus 1.

In a further example, the URL itself provides a location of data representing the text in the second language, which can then be accessed by the video processing apparatus using the URL or accessed by the remote terminal 30 to perform the translation service.

As a further example, if the audio/video data and text data are received for example in a DASH file as shown in the examples from the servers 4, 6 then the video processing apparatus 1 may retrieve the text in the first language and communicate the text to the remote terminal 30 for generating the text according to the second language and retrieving the text data for display to the user.

MPEG DASH (Dynamic Adaptive Streaming over HTTP) is a developing ISO Standard (ISO/IEC 23009-1) for adaptive streaming over HTTP. Adaptive streaming involves producing several instances of a live or an on-demand source file and making the file available to various clients depending upon their delivery bandwidth and a processing power. By monitoring CPU utilization and/or buffer status, adaptive streaming technologies can change streams when necessary to ensure continuous playback or to improve the experience. All HTTP-based adaptive streaming technologies use a combination of encoded media files and manifest files that identify alternative streams and their respective URLs. The respective players monitor buffer status HLS and CPU utilization and change streams as necessary, locating the alternate stream from the URLs specified in the manifest file. DASH is an attempt to combine the best features of all HTTP-based adaptive streaming technologies into a standard that can be utilized from mobile to other devices. All HTTP-based adaptive streaming technologies have two components: the encoded video/audio data streams and manifest files that identify the streams for the player and contain their URL addresses. For DASH, the actual video/audio data streams are called the Media Presentation, while the manifest file is called the Media Presentation Description. The media presentation defines the video sequence with one or more consecutive periods that break up the video from start to finish. Each period contains multiple adaptation sets that contain the content that comprises the audio/video signals. This content can be multiplexed, in which case there might be one adaptation set, or represented in elementary streams, which enables multiple languages to be supported for audio. Each adaptation set contains multiple representations, each a single stream in the adaptive streaming experience. Each representation is divided into media segments, essentially the chunks of data that all HTTP-based adaptive streaming technologies use. The data chunks can be presented in discrete files. The presentation in a single file helps improve file administration and caching efficiency as compared to chunked technologies that can create hundreds of thousands of files for a single audio/video event.

The DASH manifest file, called the Media Presentation Description (MPD), is an XML file that identifies the various content components and the location of all alternative streams. This enables the DASH player to identify and start playback of the initial segments, switch between representations as necessary to adapt to changing CPU and buffer status, and change adaptation sets to respond to user input, like enabling/disabling subtitles or changing languages. The MPD may therefore include the availability of multiple language sounds tracks or text for inserting into video images. However as will be appreciated not all languages may be available so that embodiments of the present technique can provide an arrangement for automatically providing text for inserting into video images in a language preferred by the user which is not available from the DASH file.

The MPD manifest file may also include an indication of a certified rating of the content of the video images and the sound track, which can be used by the video processing apparatus to apply parental controls.

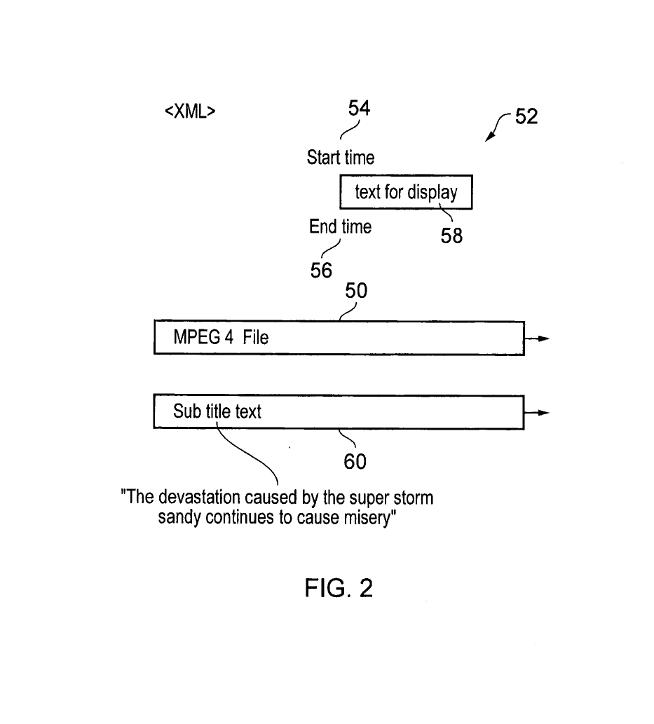

FIG. 2 provides an example illustration of a format in which text for presentation to the user may be received along with the audio/video data, which may in one example correspond to a DASH file. As shown in FIG. 2 an XML file is generated which is provided along with an MPEG 4 file 50 which contains the audio/video data compressed in accordance with MPEG 4. The XML file 52 includes an indication representing a time in which the text should be put up within the video images using a start time 54 and an end time 56 which is bracketed around the text for display 58. Thus, the subtitled text may be received within the XML file which accompanies the MPEG 4 file within a separate file 60. According to this arrangement a time at which the text is to be put up within the video images and taken down is provided as part of the file. For example, if a newscaster is providing a news story relating to the damage caused by the “super storm Sandy” then there can be provided subtitle texts representing the audio commentary being made by the newscaster. For example the text “the devastation caused by the Super-storm Sandy continues to cause misery” is shown as a representation of text data which is formed within the file in a corresponding location of the video sequence of images.

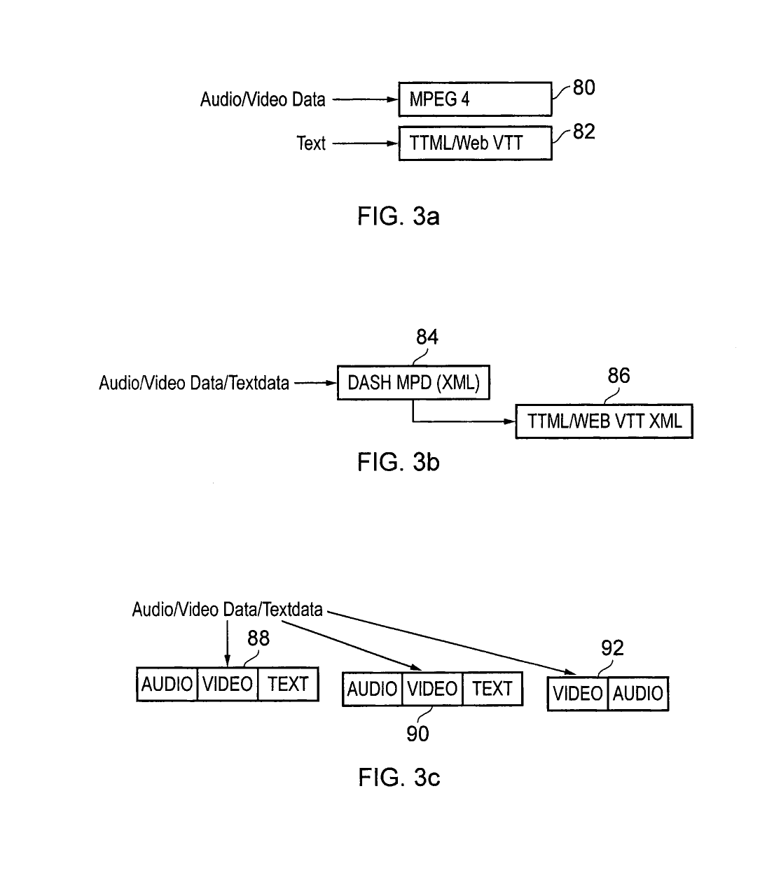

As will be appreciated from the example embodiments explained above with reference to FIGS. 1 and 2, there are various forms in which audio/video data may be transmitted with text data representing subtitles, or may refer to an associated data file which includes the text data which is to form sub-titles for reproduction within video images represented by the video data. FIGS. 3a, 3b, 3c provide three example arrangements of file structures for conveying audio/video data with text data representing the text which is to be reproduced within the video images represented by the video data as for example subtitles. In FIG. 3a, a first example is provided in which an application program generates a DASH file 80 which includes audio/video data as an MPEG 4 file 80 and separately sends text via a TTML/Web VTT file 82. FIG. 3b provides a further example in which audio/video data is transported as an DASH MPD (XML) file 84 and text data is transported as a pointer in the DASH MPD file (XML) 84, which points to a TTML/Web VTT (XML) file 86, from text data can be retrieved for the video data. Thus the Dash MPD (XML) file 84 includes a pointer to the TTL/Web VTT (XML) file 86 which includes the text data relating to the Dash MPD file. A further example is shown in FIG. 3c in which the audio/video data and the text data are transported in the same file for example as an MPEG 4 file in fragments 88, 90, 92, so that each fragment would contain some audio, some video and some text data or combination of audio/video/text data.

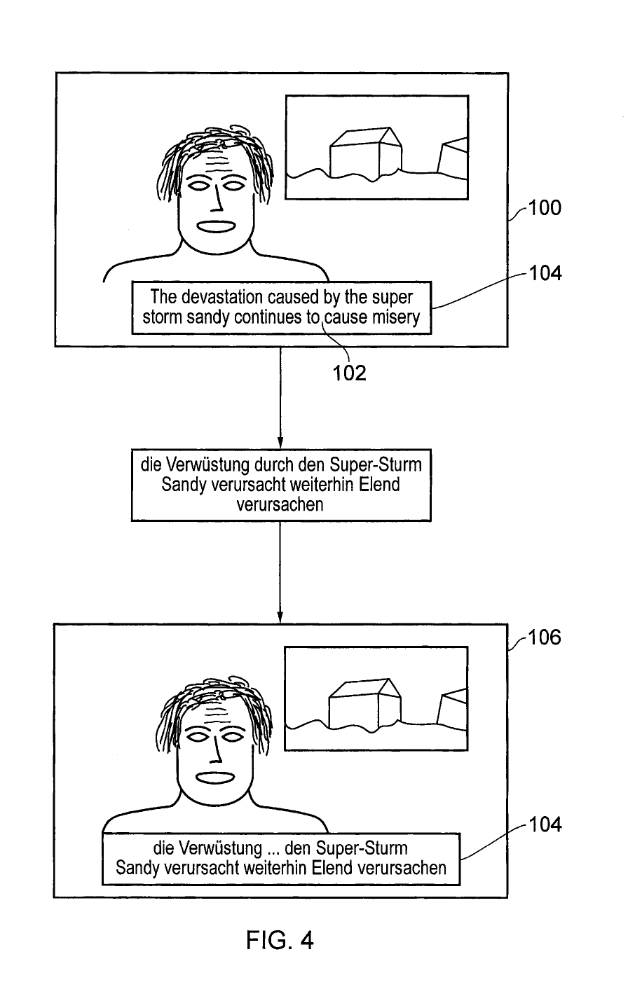

According to embodiments of the present technique, therefore, if the text in which the original language is provided is not available to the user and the user prefers a different language then the user can request that language, by indicating a user preference for sub-titles when viewing video programmes. Accordingly embodiments of the present technique can provide an arrangement in which a video processing apparatus automatically arranges for text in a user's preferred language to be obtained from the remote terminal 30. As shown in FIG. 4 for example, a picture of the representation of the newscaster provided within the video signals is shown in a graphical illustration of the video image 100 in which text is displayed 102 within a pre-defined area for text 104. After obtaining a translation of the text provided in the text file accompanying the audio/video data the video processing apparatus 1 communicates the text to the translation service provided on the remote terminal 30 as explained above with reference to FIG. 1. If, for example, the user prefers the German language then the remote terminal 30 obtains a translation of the text, for example, “the devastation caused by the super storm Sandy continues to cause misery” is translated into “die Verwustung durch den Super-Sturm Sandy verursacht weiterhin Elend verursachen”.

As shown in FIG. 4, the text on the screen in English is then replaced with German within the designated area 104 so that a user can read the subtitles in German. However, as shown in FIG. 4, some adaptation may be made to the text in the second language by either the video processing apparatus 1 or the remote terminal 30 so that the text falls within the designated area 104. The adaptation may be that the text is abbreviated or punctured, for example “durch” has been removed from the German text shown within the box 104 in the representation 106. Furthermore, the text may be made smaller by reducing the font size or word wrap around may be enabled in order to ensure that the number of lines represented by the text remains the same or similar in order that that text can fit within the area box 104.

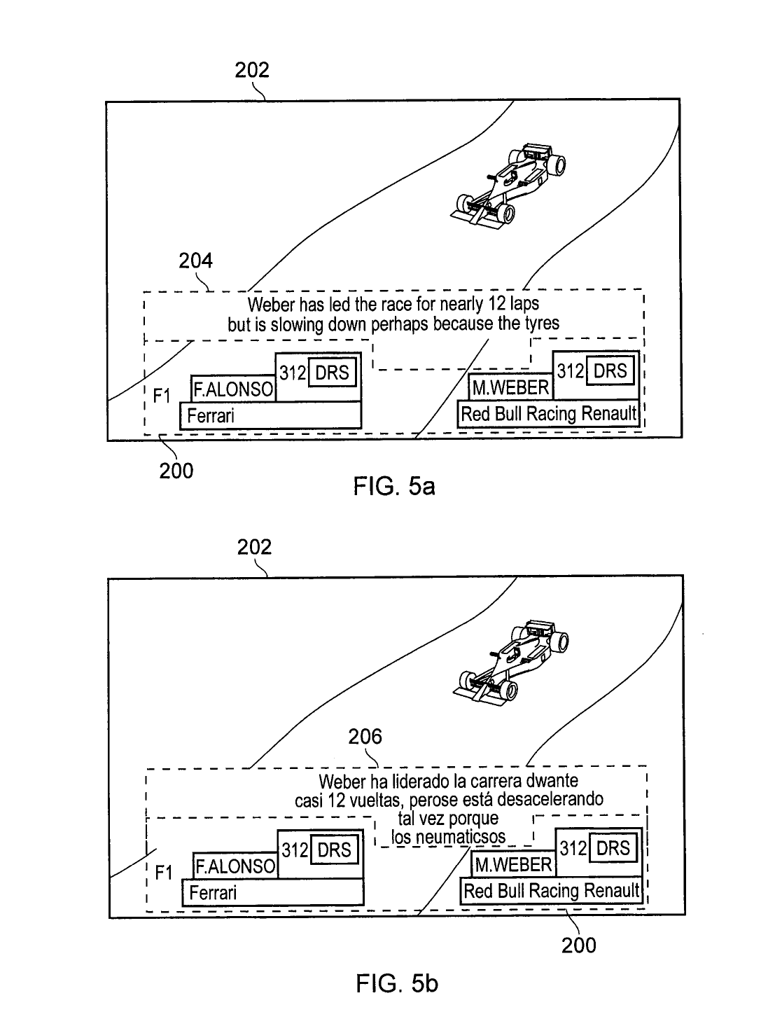

A further example adaptation of the text in the second (preferred) language is illustrated with reference to FIGS. 5a and 5b. In FIG. 5a, a motor racing competition is represented by the video and audio signals being displayed to the user which have been generated by the video processing apparatus 1. As with the previous examples, text is provided in a first language, for example, English for a generation and display to the user within the video images. However, unlike the previous examples, the audio/video data file representing the video/audio signals also includes data representing the text together with control data which gives an indication of a reserved area 200 in which the text should not be displayed so as to avoid replacing or obscuring information provided within the reserve area 200. For the example of Formula 1 motor racing, the organisers of the Formula 1 motor racing are responsible for providing the audio and video feed from cameras disposed around the track to national or commercial broadcasters. The audio and video feed is arranged to include graphical images providing parameters and data relating to a state of the race and the cars in the race. As shown in FIG. 5a, in a first representation of an image 202, a reserve area 200 is provided which shows the performance of the drivers in the first and second places, for example “F. Alonso” and “M. Weber”. Accordingly, the reserve area 200 is reserved and should not be overlaid with text providing a speech to text commentary for reading by the viewer. For this reason, the text is moved to be above the reserve area 200 in a text area 204. However, when translated into the second language, the text may have a greater number of words and therefore could expand beyond the text area 204 to infringe on the reserved area 200. Accordingly, the text is either adapted in the second language or the text area 204 is adapted to include the words of the second language by expanding the text area 200 but avoiding the reserve area 200. Such an arrangement is provided in FIG. 5b in which an adapted text area 206 is provided to accommodate a translation of the text into the second language, Spanish, but does not infringe the reserve area 200.

According to some embodiments it may be easier to translate text from a third language which may be available to a second language rather than from the first language, which may be not available depending on the availability of the respective languages. For example, if text is provided in French and the user prefers Spanish and the only other languages available are English and German, then it will be easier to translate the French into Spanish rather than English or German because Spanish and French have a common root. Accordingly, the video processing apparatus is configured to request a translation into a preferred language in accordance with the languages which are available. In one example the video processing apparatus includes a data store, storing a predetermined list of languages indicating an order of preference for translating a first language to a second language depending on the first language and the users preferred second language and other languages which may be available for example in a DASH file MPD.

In some examples the translation of the text is arranged to the effect that syllables of the second language are arranged to be regularly spaced within time with respect to the first language so that the presentation of the text on the screen corresponds substantially to that of the original first language.

In some examples the translation service performed using the remote server can be arranged to charge the user of the video processing apparatus for the translation service. For example a business entity may manage the translation service hosted by the remote server 30 and account for the translation work performed by charging the user who operates the video processing apparatus 1. For example, charges may be levied on a volume of words translated or a relative difficulty in performing the translation.

In some examples, the video and audio data representing the video images and audio sound are received with an indication of a certified rating of the content. For example, as explained above a DASH file includes a manifest MPD file which may include the certified rating for the content. In one example the video processing apparatus forming the video processing apparatus may receive the certified rating of the content and the controller is configured to adapt the text of the second language by suppressing one or more words in a predetermined list of words which have been determined to be inappropriate for the certified rating of the content of the audio sound track of the video images.

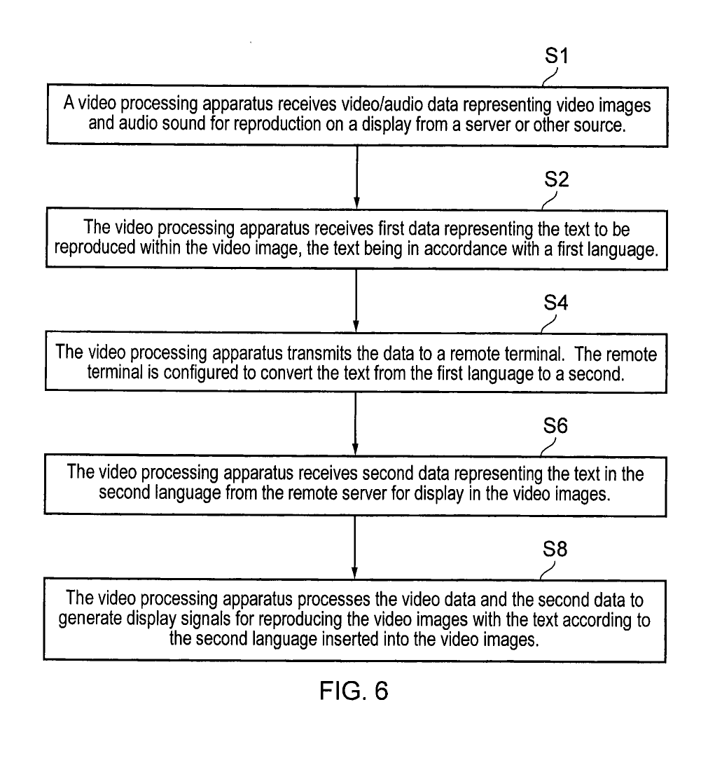

A flow diagram illustrating an operation of the video processing apparatus which is formed within or by the video processing apparatus 1 is shown in FIG. 6. FIG. 6 therefore provides a flow diagram summarising the operation of the video processing apparatus which is explained as follows:

S1: A video processing apparatus receives a file providing audio and video data which may for example be encoded using an MPEG format such as MPEG 4. The video signals represent video images for display to a user. The audio data represents an audio soundtrack for audible reproduction to the user. In one example, the audio/video data is received from a server using a streaming service.

S2: The video processing apparatus receives data accompanying the audio/video signals which represents text for display to the user within the video images. The data may represent the text according to one or more languages. The data or location of the data may be received with the video signals in HTTP streaming formats such as DASH or an XML file and may include a plurality of languages for example, English, French, Spanish and German.

S4: The video processing apparatus determines that a language preferred by the user is not available. For example the user wishes to view subtitles in Russian. Accordingly, the video processing apparatus communicates the data to a remote terminal hosting a translation service. The remote terminal then receives text and generates a version of the text in a different language, for example, Russian according to the users preference which is not available in the original data. Thus, for the example of a DASH file in which the audio/video data is conveyed, which may include multiple languages, if the preferred language is not available then the text in the preferred language is generated by communicating the text according to a language which is available to the remote terminal hosting the translation service.

S6: The video processing apparatus then receives the data representing the text in a second language from which it has been translated from the first language, for example, English into Russian and this may be received in the form of an adapted XML file or a DASH file and may be adapted to replace the text in the original language with the text in the second language so that, for example, the time information indicating a timing for display of the text within the video images is preserved.

S8: The video processing apparatus then processes the video data and the data representing the text in the second language and generates video signals for display to the user reproducing the video images with the text according to the second language inserted into the video image. The text will be associated with the video images. For the example of subtitles then the sub-titles can be inserted in the video images according to the language preferred by the user. Again, the original timing for display and removal of the text is maintained exactly as required for the first language. Some adaptation of the text of the second language may be performed to fit into an area originally provided for the text in the first language so that no more of the video images are obscured by the display of the text in the second language than would be the case with the first language. The adaptation may be include reducing font size enabling word wrap around, abbreviating or puncturing a sentence or replacing one word with a different word. Alternatively, if the video signals include an indication of a reserved area then the text area may be expanded but in a way which does not infringe the reserve area and the expanded text in the second language displayed in the expanded text area within the video images.

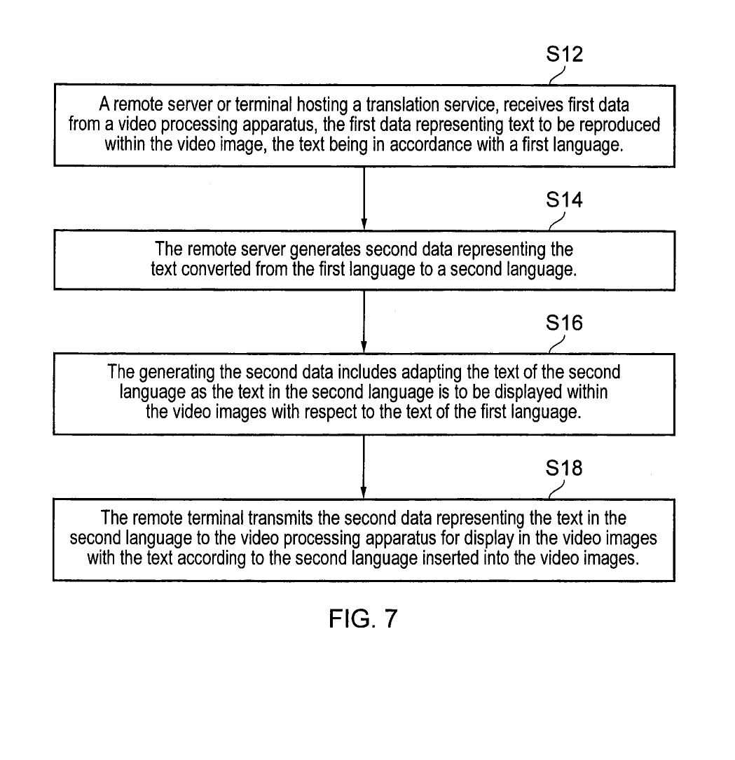

According to example embodiments a remote terminal operates to translate text for inserting into video images as explained above. In one example the operation of the remote terminal or server providing the translation service of the text is illustrated by the flow diagram of FIG. 7, which is summarised as follows:

S12: The remote terminal receives first data from the video processing apparatus, the first data representing text to be reproduced within video images, the text being in accordance with a first language.

S14: The remote terminal generates second data representing the text converted from the first language to a second language.

S16: The generating the second data includes adapting the text of the second language as the text in the second language is to be displayed within the video images with respect to the text of the first language, and

S18: The remote terminal transmits the second data representing the text in the second language to the video processing apparatus for display in the video images with the text according to the second language inserted into the video images, the text being associated with the video images.

Various further aspects and features of the present disclosure are defined in the appended claims. Various combinations may be made of the features of the dependent claims with those of the independent claims other than those specifically recited in the claim dependency. Other embodiments may include arrangements for remote mobile terminals displaying video images to receive the text data, for example a smart phone, which can access the internet to obtain a translation in accordance with embodiments of the present technique. It will be appreciated that the above description for clarity has described embodiments with reference to different functional units, circuitry and/or processors. However, it will be apparent that any suitable distribution of functionality between different functional units, circuitry and/or processors may be used without detracting from the embodiments. Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the technique may be implemented in a single unit or may be physically and functionally distributed between different units, circuitry and/or processors. Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

The following numbered clauses provide further example aspects and features of the present disclosure:

1. A video processing apparatus comprising

a communications unit configured

to receive video data representing the video images for display from a source,

to receive first data representing text to be reproduced within the video image, the text being in accordance with a first language,

a controller configured

to communicate the first data to a remote terminal using the communications unit, the remote terminal being configured to convert the text from the first language to a second language to form second data,

to receive the second data from the remote terminal representing the text in the second language, and a video processor configured

to process the video data and the second data to generate display signals for reproducing the video images with the text according to the second language inserted onto the video images, the text being associated with the video images.

2. A video processing apparatus according to clause 1, wherein the communications unit is configured to receive control data providing an indication of an area of the video images in which the text data according to the first language is to be displayed and the controller is configured to generate the video signals so that the text in the second language falls within the area for the text.

3. A video processing apparatus according to clause 1 or 2, wherein the controller adapts the second text in the second language to fall within the area allocated to the sub-titles.

4. A video processing apparatus according to clause 1 or 2, wherein the controller is configured to communicate to the remote terminal the indication of the area of the video images in which the sub-title text is to fall, and to receive from the remote terminal the second data representing the text in the second language, which has been adapted to fall within the area allocated to the sub-titles.

5. A video processing apparatus according to any of clauses 2 to 4, wherein the controller is configured to adapt the text according to the second language in accordance with the area available for the text in the second language by one or more of changing the font size of the text of the second language, dropping words from the second language, abbreviating words in the second language or wrapping words around to reduce space.

6. A video processing apparatus according to any preceding clause, wherein the video data includes an indication of a reserved area of the displayed video images in which the text according to the second language cannot be displayed and the adapting the text of the second language includes changing an area in the displayed video images in which the text is displayed, which excludes the reserved area.

7. A video processing apparatus according to clause 1, wherein the video data includes an indication of a certified rating of the video signals and the controller is configured to adapt the text of the second language by suppressing one or more words in a predetermined list of words which have been determined to be inappropriate for the certified rating of the video signals.

8. A video processing apparatus according to any preceding clause, wherein the controller receives an indication of the second language for displaying the text of the first language, and in accordance with the second language selects one of the first language or a third language for communicating to the remote terminal for preparing a translation into the second language in accordance with a predetermined list of available languages.

9. A video processing apparatus according to any preceding clause, wherein the first data representing the text in the first language received by the video processing apparatus comprises a universal resource locator identifying an address of the text on a server accessed using an internet protocol.

10. A video processing apparatus according to any of clauses 1 to 8, wherein the communications unit is configured to receive an extended mark-up language file, the extended mark-up language file including the first data representing the text to be reproduced within the video image, and control data to provide an indication of a timing of when to put-up and to remove the text within the video images, and the controller is configured to communicate the extended mark-up language file to the remote terminal using the communications unit and to receive an adapted version of the extended mark-up language file from the remote terminal in which the first data representing the text in the first language has been replaced with second data representing the text in the second language.

11. A method of generating video images comprising

receiving video data representing the video images for display from a source,

receiving first data representing text to be reproduced within the video image, the text being in accordance with a first language,

communicating the first data to a remote terminal using a communications unit, the remote terminal being configured to convert the text from the first language to a second language to form second data,

receiving second data representing the text in the second language,

processing the video data and the second data to generate display signals for reproducing the video images with the text according to the second language inserted into the video images, the text being associated with the video images.

12. A method according to clause 11, comprising

receiving control data providing an indication of an area of the video images in which the text data according to the first language is to be displayed, the method comprising

generating the video signals so that the text in the second language falls within the area for the text.

13. A method according to clause 12, comprising

adapting the text in the second language to fall within the area allocated to the sub-titles.

14. A method according to any of clauses 12 or 13, the method comprising

communicating to the remote terminal the indication of the area of the video images in which the sub-title text is to fall, and

receiving from the remote terminal the second data providing the text in the second language, which has been adapted to fall within the area allocated to the sub-titles.

15. A method according to any of clauses 11 to 14, the method comprising

adapting the text according to the second language in accordance with the area available for the text in the second language by one or more of changing the font size of the text of the second language, dropping words from the second language, abbreviating words in the second language or wrapping words around to reduce space.

16. A method according to any of clauses 11 to 15, wherein the video signals include an indication of a reserved area of the displayed video images in which the text according to the second language cannot be displayed and the adapting the text of the second language includes changing an area in the video images in which the text is displayed, which excludes the reserved area.

17. A method according to clause 11, wherein the video signals include an indication of a certified rating of the video signals and the adapting the text of the second language includes suppressing one or more words in a predetermined list of words which have been determined to be inappropriate for the certified rating of the video data.

18. A method according to any of clauses 11 to 17, comprising

receiving an indication of the second language for displaying the text of the first language, and

selecting one of the first language or a third language for communicating the text to the remote terminal for preparing a translation into the second language in accordance with a predetermined list of available languages.

19. A method according to any of clauses 11 to 18, wherein the first data representing the text in the first language comprises a universal resource locator, and the method comprises identifying an address of the text in the first language on a server accessed using an internet protocol.

20. A method according to any of clauses 11 to 19, comprising

receiving an extended mark-up language file, the extended mark-up language file including the first data representing the text in the first language to be reproduced within the video image, and control data to provide an indication of a timing of when to put-up and to remove the text within the video images, and

communicating the extended mark-up language file to the remote terminal using the communications unit, and

receiving an adapted version of the extended mark-up language file from the remote terminal in which the first data representing the text in the first language has been replaced with second data representing the text in the second language.

21. A remote server for translating text for inserting into video images, the remote server being configured

to receive first data from a video processing apparatus, the first data representing text to be reproduced within video images, the text being in accordance with a first language,

to generate second data representing the text converted from the first language to a second language, the generating the second data including adapting the text of the second language as the text in the second language is to be displayed within the video images with respect to the text of the first language, and

to transmit the second data representing the text in the second language to the video processing apparatus for display in the video images with the text according to the second language inserted into the video images. 22. A remote server according to clause 21, wherein the remote server is configured

to receive an indication of an area of the video images in which the text data according to the first language is to be displayed within the video images, and

to adapt the text in the second language so that the text in the second language falls within the area for the text allocated for sub-titles.

23. A remote server according to clause 22, wherein the remote server is configured to adapt the text according to the second language in accordance with the area available for the text in the second language by one or more of changing the font size of the text of the second language, dropping words from the second language, enabling word wrap or abbreviating words in the second language to reduce space.

24. A remote server according to clause 22, wherein the video data includes an indication of a certified rating of the content of the video data, and the remote server is configured to adapt the text of the second language by suppressing one or more words in a predetermined list of words which have been determined to be inappropriate for the certified rating of the video signals.

25. A remote server according to any of clauses 21 to 24, wherein the remote server is configured to receive an indication of the second language and in accordance with the second language selects one of the first language or a third language for preparing a translation into the second language in accordance with a predetermined list of available languages.

26. A remote server according to any of clauses 21 to 25, wherein the remote server is configured to debit an account of a user in accordance with the translation from the first to the second language.

27. A method of translating text for inserting into video images, the method comprising

receiving first data from a video processing apparatus, the first data representing text to be reproduced within the video image, the text being in accordance with a first language,

generating second data representing the text converted from the first language to a second language, the generating the second data including adapting the text of the second language as the text in the second language is to be displayed within the video images with respect to the text of the first language, and

transmitting the second data representing the text in the second language to the video processing apparatus for display in the video images with the text according to the second language inserted into the video images.

28. A method according to clause 27, comprising

receiving an indication of an area of the video images in which the text data according to the first language is to be displayed within the video images, and the adapting the text of the second language comprises

adapting the text in the second language so that the text in the second language falls within the area for the text allocated for sub-titles.

29. A method according to clause 28, wherein the adapting the text in the second language comprises

adapting the text according to the second language in accordance with the area available for the text in the second language by one or more of changing the font size of the text of the second language, dropping words from the second language or abbreviating words in the second language to reduce space.

30. A method according to clause 28, wherein the video data includes an indication of a certified rating of the content of the video data, and the method comprises

adapting the text of the second language by suppressing one or more words in a predetermined list of words which have been determined to be inappropriate for the certified rating of the video signals.

31. A method according to any of clauses 27 to 30, comprising

receiving an indication of the second language and in accordance with the second language selects one of the first language or a third language for preparing a translation into the second language in accordance with a predetermined list of available languages.

32. A method according to any of clauses 27 to 31, comprising

debiting an account of a user of the translation service in accordance with the translation from the first to the second language.

1. A video processing apparatus comprising
a communications unit circuitry configured
to receive video data representing the video images for display from a source,
to receive first data representing text to be reproduced within the video image, the text being in accordance with a first language,
a controller circuitry configured
to communicate the first data to a remote terminal using the communications unit, the remote terminal being configured to convert the text from the first language to a second language to form second data,
to receive the second data from the remote terminal representing the text in the second language, and a video processor circuitry configured
to process the video data and the second data to generate display signals for reproducing the video images with the text according to the second language inserted onto the video images, the text being associated with the video images and wherein the communications unit circuitry is configured to receive control data providing an indication of an area of the video images in which the text data according to the first language is to be displayed and the controller is configured to generate the video signals so that the text in the second language falls within the area for the text and
wherein the controller circuitry is configured to adapt the text according to the second language in accordance with the area available for the text in the second language by changing the font size of the text of the second language and by one or more of dropping words from the second language, abbreviating words in the second language or wrapping words around to reduce space.

2. A video processing apparatus as claimed in claim 1, wherein the controller circuitry receives an indication of the second language for displaying the text of the first language, and in accordance with the second language selects one of the first language or a third language for communicating to the remote terminal for preparing a translation into the second language in accordance with a predetermined list of available languages.

3. A video processing apparatus as claimed in claim 1, wherein the first data representing the text in the first language received by the video processing apparatus comprises a universal resource locator identifying an address of the text on a server accessed using an interne protocol.

4. A video processing apparatus as claimed in claim 1, wherein the communications unit circuitry is configured to receive an extended mark-up language file, the extended mark-up language file including the first data representing the text to be reproduced within the video image, and control data to provide an indication of a timing of when to put-up and to remove the text within the video images, and the controller circuitry is configured to communicate the extended mark-up language file to the remote terminal using the communications unit circuitry and to receive an adapted version of the extended mark-up language file from the remote terminal in which the first data representing the text in the first language has been replaced with second data representing the text in the second language.

5. A method of generating video images comprising
receiving video data representing the video images for display from a source,
receiving first data representing text to be reproduced within the video image, the text being in accordance with a first language,
communicating the first data to a remote terminal using a communications unit, the remote terminal being configured to convert the text from the first language to a second language to form second data,
receiving second data representing the text in the second language,
processing the video data and the second data to generate display signals for reproducing the video images with the text according to the second language inserted into the video images, the text being associated with the video images.

6. A method as claimed in claim 5, comprising
receiving control data providing an indication of an area of the video images in which the text data according to the first language is to be displayed, the method comprising
generating the video signals so that the text in the second language falls within the area for the text.

7. A method as claimed in claim 5, the method comprising
adapting the text according to the second language in accordance with the area available for the text in the second language by changing the font size of the text of the second language and by one or more of dropping words from the second language, abbreviating words in the second language or wrapping words around to reduce space.

8. A method as claimed in claim 5, wherein the video signals include an indication of a reserved area of the displayed video images in which the text according to the second language cannot be displayed and the adapting the text of the second language includes changing an area in the video images in which the text is displayed, which excludes the reserved area.

9. A method as claimed in claim 5, comprising
receiving an indication of the second language for displaying the text of the first language, and
selecting one of the first language or a third language for communicating the text to the remote terminal for preparing a translation into the second language in accordance with a predetermined list of available languages.

10. A method as claimed in claim 5, wherein the first data representing the text in the first language comprises a universal resource locator, and the method comprises identifying an address of the text in the first language on a server accessed using an internet protocol.

11. A method as claimed in claim 5, comprising
receiving an extended mark-up language file, the extended mark-up language file including the first data representing the text in the first language to be reproduced within the video image, and control data to provide an indication of a timing of when to put-up and to remove the text within the video images, and
communicating the extended mark-up language file to the remote terminal using the communications unit, and
receiving an adapted version of the extended mark-up language file from the remote terminal in which the first data representing the text in the first language has been replaced with second data representing the text in the second language.

12. A remote server for translating text for inserting into video images, the remote server being configured
to receive first data from a video processing apparatus, the first data representing text to be reproduced within video images, the text being in accordance with a first language,
to generate second data representing the text converted from the first language to a second language, the generating the second data including adapting the text of the second language as the text in the second language is to be displayed within the video images with respect to the text of the first language, and
to transmit the second data representing the text in the second language to the video processing apparatus for display in the video images with the text according to the second language inserted into the video images, and wherein the remote server is configured
to receive an indication of an area of the video images in which the text data according to the first language is to be displayed within the video images, and
to adapt the text in the second language so that the text in the second language falls within the area for the text allocated for sub-titles.

13. A remote server as claimed in claim 12, wherein the remote server is configured to adapt the text according to the second language in accordance with the area available for the text in the second language by one or more of changing the font size of the text of the second language, dropping words from the second language, enabling word wrap or abbreviating words in the second language to reduce space.

14. A remote server as claimed in claim 12, wherein the video data includes an indication of a certified rating of the content of the video data, and the remote server is configured to adapt the text of the second language by suppressing one or more words in a predetermined list of words which have been determined to be inappropriate for the certified rating of the video signals.

15. A remote server as claimed in claim 12, wherein the remote server is configured to receive an indication of the second language and in accordance with the second language selects one of the first language or a third language for preparing a translation into the second language in accordance with a predetermined list of available languages.

16. A remote server as claimed in claim 12, wherein the remote server is configured to debit an account of a user in accordance with the translation from the first to the second language.

17. A non-transitory computer readable medium including computer program instructions, which when executed by a computer causes the computer to perform the method of claim 5.
